(19) United States
(12) Patent Application Publication
(10) Pub. No.: US 2015/0066659 A1
(43) Pub. Date: Mar. 5, 2015

(54) Ranking Content Items Based on a Value of Learning

(71) Applicant: Google Inc., Mountain View, CA (US)

(72) Inventors: Patrick Hummel, Cupertino, CA (US); Randolph P. McAfee, San Marino, CA (US); Martin Andre Monroe Zinkevich, San Jose, CA (US)

(21) Appl. No.: 14/011,524

(22) Filed: Aug. 27, 2013

(51) Int. Cl. G06Q 30/02

(52) U.S. Cl. CPC G06Q 30/0275
USPC 705/14.71

(57) ABSTRACT

Methods, systems, and apparatus include computer programs encoded on a computer-readable storage medium, including a method for ranking content. A request for content is received. Eligible content items are identified, including a first eligible content item for which an uncertainty level of an associated expected click-through rate is above a predefined threshold. A subset of the eligible content items is evaluated, including the first eligible content item including producing a score. The score is a product of an associated bid and click-through rate for a given eligible content item. Producing the score includes adjusting a product of a bid times an expected click-through rate for the first eligible content item by a value of learning that represents a value for exploring the first eligible content item as a response to the request. The subset of eligible content items is ranked based on the produced scores.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented. However, when content is new, the likelihood that a user will interact with the content may be unknown or difficult to measure.

### SUMMARY

In general, one innovative aspect of the subject matter described in this specification can be implemented in methods that include a computer-implemented method for ranking content. The method includes receiving a request for content. The method further includes identifying a plurality of eligible content items including a first eligible content item for which an uncertainty level of an expected click-through rate for the first eligible content item is above a predefined threshold. The method further includes evaluating a subset of the eligible content items including the first eligible content item including producing a score, wherein the score is a product of an associated bid and a click-through rate for a given eligible content item, and wherein producing a score for the first eligible content item includes adjusting a product of a bid times expected click-through rate for the first eligible content item by a value of learning that represents a value for exploring the first eligible content item as a response to the request. The method further includes ranking the subset of eligible content items based on the produced scores.

These and other implementations can each optionally include one or more of the following features. The value of learning can include an adjustment for one or more of a density of distribution of highest competing bids, a time value of money discount, or a variance discount that reflects a value of learning that is varied based on how much is known already about the first eligible content item. The value of learning can be computed using a score in accordance with the formula:

$$x + \frac{f ( x ) {σ}^{2} ( x )}{2 ( 1 - δ ) ( k + 1 )}$$

wherein x is an expected cost per thousand (eCPM) of the first eligible content item with an unknown eCPM, wherein f(x) is a density of a distribution of highest-competing eCPM bids evaluated at x, wherein the distribution reflects a random variation in the eCPM of the highest-competing bid that a given eligible content item faces from auction-to-auction, wherein σ²(x) is an estimated variance in the eCPM of the first eligible content item, wherein the estimated variance reflects an uncertainty in a true eCPM for the first eligible content item; wherein k is the number of impressions that the first eligible content item has received since it was created, and wherein δ is a discount factor for the first eligible content item. The density of distribution of highest competing bids can account for random variation in competing bids that may be placed in the future that will compete with the first eligible content item. The time value of money discount can reflect an expected value of revenue to be received in the future from auctions in which the first eligible content item will compete. The variance discount can reduce the value of learning as more is learned about the first eligible content item. The value of learning can decrease as the uncertainty level of the expected click-through rate for the first eligible content item decreases over time. Adjusting can include increasing a score for the first eligible content item. Evaluating the subset of eligible content items can include conducting an auction. The method can further include selecting a content item for publication responsive to the request based on the ranking.

In general, another innovative aspect of the subject matter described in this specification can be implemented in computer program products that include a computer program product tangibly embodied in a computer-readable storage device and comprising instructions. The instructions, when executed by one or more processors, cause the processor to: identify a plurality of eligible content items including a first eligible content item for which an uncertainty level of an expected click-through rate for the first eligible content item is above a predefined threshold; evaluate a subset of the eligible content items including the first eligible content item including producing a score, wherein the score is a product of an associated bid and a click-through rate for a given eligible content item, and wherein producing a score for the first eligible content item includes adjusting a product of a bid times expected click-through rate for the first eligible content item by a value of learning that represents a value for exploring the first eligible content item as a response to the request; rank the subset of eligible content items based on the produced scores; and select a content item for publication responsive to the request based on the ranking.

These and other implementations can each optionally include one or more of the following features. The value of learning can include an adjustment for one or more of a density of distribution of highest competing bids, a time value of money discount, or a variance discount that reflects a value of learning that is varied based on how much is known already about the first eligible content item. The value of learning can be computed using a score in accordance with the formula:

$$x + \frac{f ( x ) {σ}^{2} ( x )}{2 ( 1 - δ ) ( k + 1 )}$$

wherein x is an expected cost per thousand (eCPM) of the first eligible content item with an unknown eCPM, wherein f(x) is a density of a distribution of highest-competing eCPM bids evaluated at x, wherein the distribution reflects a random variation in the eCPM of the highest-competing bid that a given eligible content item faces from auction-to-auction, wherein σ²(x) is an estimated variance in the eCPM of the first eligible content item, wherein the estimated variance reflects an uncertainty in a true eCPM for the first eligible content item; wherein k is the number of impressions that the first eligible content item has received since it was created, and wherein δ is a discount factor for the first eligible content item. The density of distribution of highest competing bids can account for random variation in competing bids that may be placed in the future that will compete with the first eligible content item. The time value of money discount can reflect an expected value of revenue to be received in the future from auctions in which the first eligible content item will compete.

In general, another innovative aspect of the subject matter described in this specification can be implemented in systems, including a system comprising a content identification engine that identifies a plurality of eligible content items from an inventory of content items, the identification based in part on characteristics of the eligible content items matching characteristics associated with a request for content, the eligible content items including a first eligible content item for which an uncertainty level of an expected click-through rate for the first eligible content item is above a predefined threshold; a scoring engine that evaluates a subset of the eligible content items to produce scores for use in an auction for selecting at least one of the eligible contents in the subset, the scores for the eligible content items being based on a product of an associated bid and an expected click-through rate (eCTR) for the given eligible content, and the score for the first eligible content item being based on a function of a bid times an expected click-through rate and being adjusted by a value of learning that represents a value for exploring the first eligible content item as a response to the request; a ranking engine that ranks the subset of eligible content items, including the first eligible content item, using the associated scores; and a request handler that handles requests for content received by a content management system, the content management system selecting and providing content in response to requests for content.

These and other implementations can each optionally include one or more of the following features. The value of learning can include an adjustment for one or more of a density of distribution of highest competing bids, a time value of money discount, or a variance discount that reflects a value of learning that is varied based on how much is known already about the first eligible content item. The value of learning can be computed using a score in accordance with the formula:

$$x + \frac{f ( x ) {σ}^{2} ( x )}{2 ( 1 - δ ) ( k + 1 )}$$

wherein x is an expected cost per thousand (eCPM) of the first eligible content item with an unknown eCPM, wherein f(x) is a density of a distribution of highest-competing eCPM bids evaluated at x, wherein the distribution reflects a random variation in the eCPM of the highest-competing bid that a given eligible content item faces from auction-to-auction, wherein σ²(x) is an estimated variance in the eCPM of the first eligible content item, wherein the estimated variance reflects an uncertainty in a true eCPM for the first eligible content item; wherein k is the number of impressions that the first eligible content item has received since it was created, and wherein δ is a discount factor for the first eligible content item. The density of distribution of highest competing bids can account for random variation in competing bids that may be placed in the future that will compete with the first eligible content item. The time value of money discount can reflect an expected value of revenue to be received in the future from auctions in which the first eligible content item will compete.

Particular implementations may realize none, one or more of the following advantages. For certain content items (e.g., a new advertisement having an unknown expected click-through rate), techniques can be used to quantifiably estimate a value of learning that can be realized when the content item is presented. One example of the value can be learning related to an expected click-through rate of the content item. An estimated value of learning, for example, can be used in a content selection process to more efficiently allocate content items and to take into account both an immediate value of showing a content item as well as the value of learning more about what happens when a content item is presented (and hence more information is available to determine an expected click-through rate (eCTR) of the content tent item). Systems and methods proposed can rank content items based at least in part on a density of the distribution of highest competing bids. In such systems and uses, an amount of active exploration that takes place can be varied. When the density of the distribution is relatively large, then new information about a content item (e.g., that helps to refine the eCTR) can be valuable to learn (e.g., since the content item can be relatively more likely to have an effect on future auction outcomes). When the density of the distribution is relatively smaller, then any new information gained that produces a better estimate of eCTR of the content item can be relatively less likely to have an effect on future auction outcomes, and there can be relatively less value to exploring the content item.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 shows an example system for adjusting a bid-related score for a content item by a value of learning associated with the content item's estimated performance.

FIG. 3 is a flowchart of an example process for adjusting a bid-related score for a content item by a value of learning associated with the content item's estimated performance.

FIG. 4 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and mechanisms for adjusting a bid-related score for a content item by a value of learning associated with the content item's performance. For example, the click-through rate of some content items (e.g., new or fairly new advertisements) may not be known with certainty. Thus, the effective cost per thousand impressions (eCPM) is also not known with certainty. In some implementations, scores that are calculated for use in an auction for these content items can be adjusted by a value of learning. The adjustment, for example, can be an increase to a conventional score when the value of learning is high (or above a threshold). In some implementations, a score is calculated as a product of a bid times a quality factor, wherein the quality factor includes a measure of an expected click-through rate for the content item. An adjusted score can be calculated that is based on a value of learning component. In some implementations, the adjustment can be an increase that represents a value of learning more information so as to provide a better estimate for the eCTR for the content item. Adjusting the scores will allow for exploration of content items where traditionally they may not have been presented. The value of learning, for example, can represent a value for exploring the first eligible content item as a response to the request.

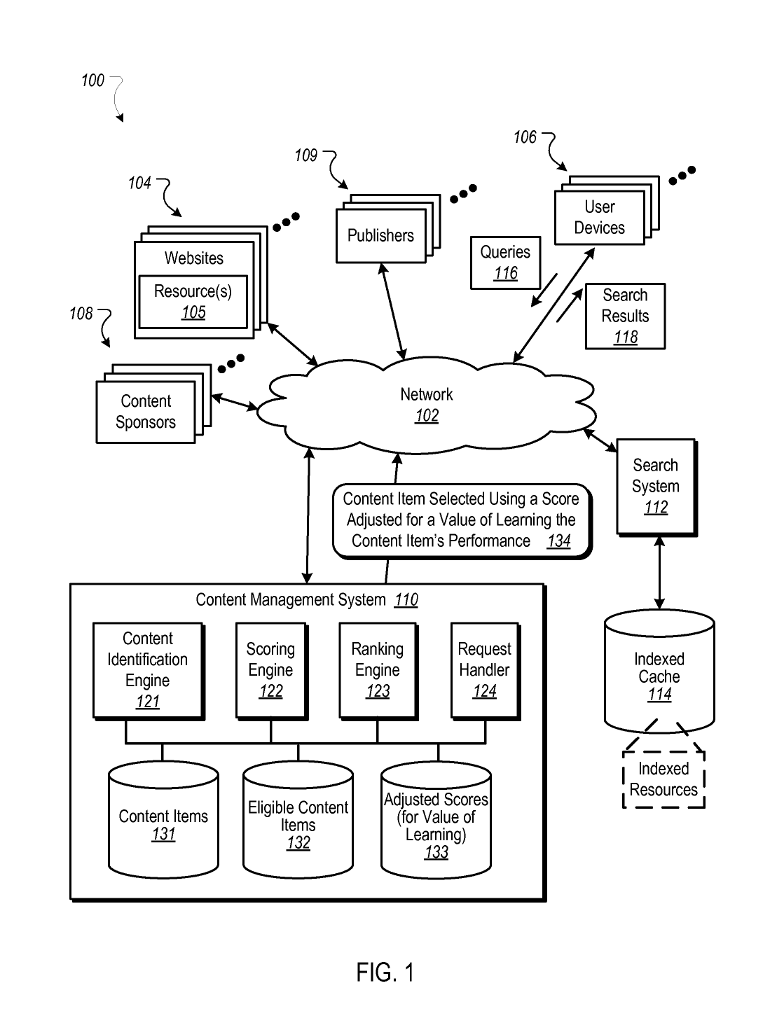

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

In some implementations, in response to a request for content, the content management system 110 can provide a content item 134 that is selected, for example, in an auction using a bid-related score adjusted for a value of learning associated with the content item's performance. For example, the content item 134 can be selected by the content management system 110 (or its components) over other eligible content items that may or may not have adjusted scores.

The content management system 110 can include plural engines. A content identification engine 121, for example, can identify a plurality of eligible content items from an inventory of content items. The identification can be made, for example, because the eligible content items have characteristics that match a received request for content. The eligible content items can include a first eligible content item for which an uncertainty level as to the certainty of an expected click-through rate for the first eligible content item is above a predefined threshold. For example, the first eligible content item may have insufficient impressions to predict, with certainty, an eCPM and an eCTR. The predefined threshold, for example, can be based on a count of impressions. For example, content items having fewer than a threshold number of N impressions can have an uncertainty level that will cause an adjusted score to be produced. Other factors can be used to determine an uncertainty level. As an example, the uncertainty level can be affected by a number of clicks that a given content item has received. For example, there can be more uncertainty in the eCPM of a content item that has received a smaller number of clicks, since there is less evidence on a true eCPM of that content item. In another example, the uncertainty level can be affected by a cost-per-click bid of the content sponsor. In this example, there can be more uncertainty in the eCPM of a content sponsor with a higher bid, e.g., if the click-through rate is multiplied by the bid to determine the eCPM. In another example, the uncertainty level can be affected by the number of impressions or clicks received by other content items that share similar features as the content item in question. In this example, there can be less uncertainty in the eCPM of a content item if significant evidence exists on the actual click-through rates of other content items that have similar or identical features with the content item in question. In another example, the uncertainty level can be affected by an extent of disagreements between different machine learning systems as to a true eCPM of a content item. In this example, there can be uncertainty about the true eCPM of a content item when there is greater disagreement between different machine learning systems as to the content item's true eCPM.

A scoring engine 122, for example, can evaluate a subset of the eligible content items to produce scores for use in an auction for selecting at least one of the eligible contents in the subset. The scores produced for the eligible content items can include at least an adjusted score produced for a first eligible content item. For example, the scores produced for each of the eligible content items can be a product of an associated bid and an expected click-through rate (eCTR) for the given eligible content. The score produced for the first eligible content item can be an adjusted product (or other function) of a bid times an expected click-through rate. In some implementations, the product can be adjusted by a value of learning that represents a value for exploring the first eligible content item as a response to the request.

A ranking engine 123, for example, can rank eligible content items, including the first eligible content item, using the associated scores produced by the scoring engine 122. As a result of the ranking, for example, the first eligible content item may be ranked higher than the other eligible content items because of the inclusion of (and adjustment by) the value of learning in the score computed for the first eligible content item. Other results of the ranking can occur, e.g., including a ranking in which the highest-ranked eligible content item is not the first eligible content item.

A request handler 124, for example, can handle requests for content received by the content management system 110, and in response to each request, provide one or more content items to the requestor. For example, the request for content can be a request to fill a content item slot on a web page displayed in a browser on the user device 106. In response to the request for content, the request handler 124 can provide a content item, e.g., an advertisement having characteristics that match the characteristics of an advertisement slot on the user device 106. The request handler 124 can also provide search results 118 in response to received search queries 116.

The environment 100 can include plural data stores, which can be stored locally by the content management system 110, stored somewhere else and accessible using the network 102, generated as needed from various data sources, or some combination of these. An inventory of content items 131, for example, can include content items (e.g., advertisements) that can be used for selection of one or more content items responsive to a request. For example, the request can be the search query 116, a request to fill a content item slot (e.g., an advertisement slot), or some other request.

A data store of eligible content items 132, for example, can include one or more content items identified from the inventory of content items 131 that are eligible to be served because they match the characteristics of a given request for content. The eligible content items 132 can be determined in real-time, e.g., in response to a particular request for content.

A data store of adjusted scores 133 can include bid-related scores that are computed, and in some implementations computed in real-time. The adjusted scores can include a value of learning component that can represent a value for exploring an eligible content item as a response to a request. The adjusted scores 133 can be used along with non-adjusted scores in an auction or other decision-making process for selecting content for delivery to a user.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as republishing or sharing the content item. Other actions that constitute a conversion can also be used.

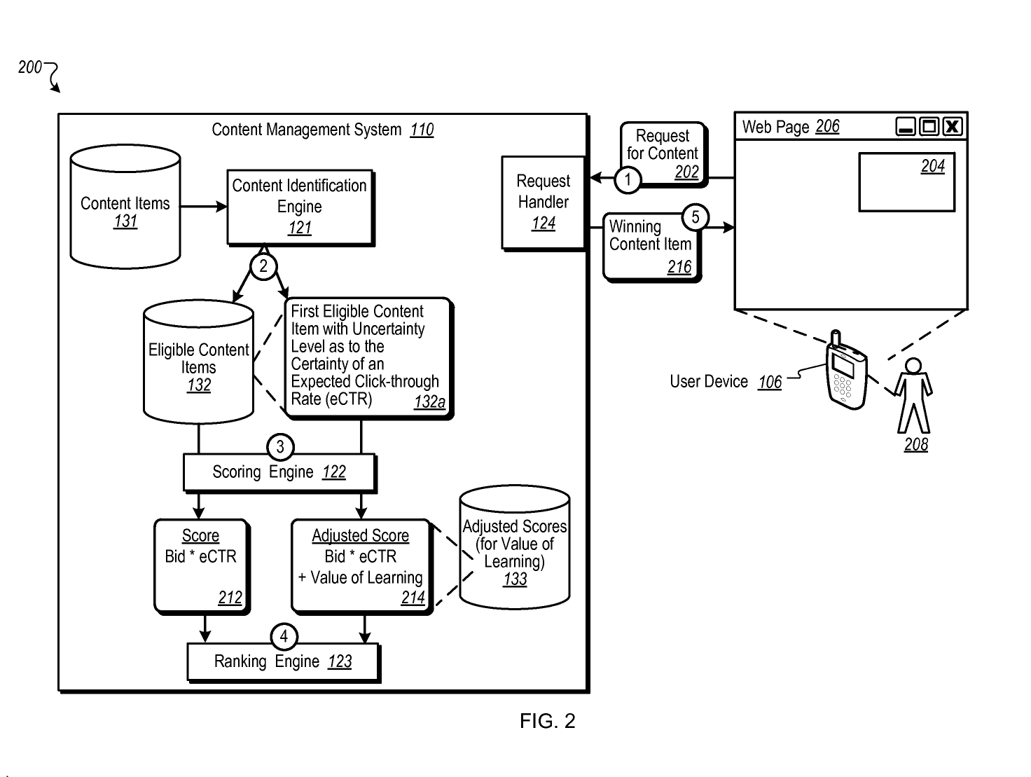

FIG. 2 shows an example system 200 for adjusting a bid-related score for a content item by a value of learning associated with the content item's estimated performance. The value of learning, for example, may be determined when the content item has an uncertainty level as to the expected click-through rate (eCTR) associated with the content item. The content item, for example, can be one of a subset of eligible content items 132 that are eligible for selection in response to a request for content 202. To provide a content item in response to the request for content 202, for example, the system 200 can use the engines 121-124, each of which can be associated with one or more of following example stages 1-5 that are used to describe a more detailed example.

At stage 1, for example, the content management system 110 can receive the request for content 202. For example, the request for content 202 can be a request for a content item, e.g., an advertisement to fill an advertisement slot 204 on a web page 206 viewed by a user 208. There can be other types of requests for content 202 (e.g., for other types of content item slots) received from the user device 106.

At stage 2, for example, the content identification engine 121 can identify a plurality of eligible content items, e.g., the eligible content items 132. The identified eligible content items 132 can include a first eligible content item 132a for which an uncertainty level as to an expected click-through rate for the first eligible content item 132a is above a predefined threshold.

At stage 3, for example, the scoring engine 122 can evaluate a subset of the eligible content items 132 including the first eligible content item 132a. The evaluation performed by the scoring engine 122 can include producing scores associated with each of the eligible content items 132, including the first eligible content item 132a. For example, each one of scores 212 associated with the corresponding ones of the eligible content items 132 can be a product of an associated bid and an expected click-through rate for the given eligible content item. A score 214 associated with the first eligible content item 132a, for example, can be an adjusted product of a bid times an expected click-through rate for the first eligible content item 132a. Specifically, the product is adjusted by a value of learning that represents a value for exploring the first eligible content item as a response to the request. Detailed information regarding the value of learning and how it is determined is provided below.

At stage 4, for example, the ranking engine 123 can rank the subset of eligible content items 132, including the first eligible content item 132a, based on the produced scores 212 and 214. In the current example, the first eligible content item 132a can perform better in the ranking (than otherwise would occur) due to the addition of the value of learning. Specifically, the value of learning can be used to raise the score of the first eligible content item 132a. There can be more than one eligible content item for which a value of learning is used to generate an adjusted score, or there may be no such eligible content items.

At stage 5, for example, the content management system 110 can select a content item for publication responsive to the request and based on the ranking. For example, the content management system 110 can provide a highest-ranked content item 216 responsive to the request for content 202. The highest-ranked content item 216 can be the first eligible content item 132a, for example, when the ranking engine 123 has ranked the first eligible content item 132a higher than the scored subset of the eligible content items 132.

In some implementations, the value of learning can include an adjustment for one or more of a density of distribution of highest competing bids, a time value of money discount, or a variance discount that reflects a value of learning that is varied based on how much is known already about the first eligible content item. In some implementations, other adjustments can be used, and more than one adjustment can be made.

In some implementations, the adjustment made for the density of distribution of highest competing bids can account for random variation in competing bids that may be placed in the future that will compete with the first eligible content item. As an example, the density of distribution of highest competing bids can reflect a random variation in the eCPM of the highest competing bid that the first eligible content item will face from auction-to-auction. The competing bids, for example, can include bids associated with eligible content items for which a relative certainty exists as to an expected click-through rate.

In some implementations, the adjustment made for the time value of money discount can reflect an expected value of revenue to be received in the future from auctions in which the first eligible content item will compete. For example, the time value of money discount can be a discount factor that reflects a value (e.g., placed by an auction) of a monetary amount received in the future (e.g., one year from now) relative to a value amount placed on a monetary amount received today.

In some implementations, the adjustment made for the variance discount can reduce the value of learning as more is learned about the first eligible content item. As an example, the variance discount can represent an estimated variance in the eCPM of the first eligible content item.

In some implementations, using these and/or other adjustment factors, the value of learning can be computed using a score in accordance with a formula, one example score being:

$$x + \frac{f ( x ) {σ}^{2} ( x )}{2 ( 1 - δ ) ( k + 1 )} \qquad ( 1 )$$

In the example formula, the term x is an expected cost per thousand (eCPM) of the first eligible content item with an unknown eCPM. The term f(x) is a density of a distribution of highest-competing eCPM bids evaluated at x. The distribution reflects a random variation in the eCPM of the highest-competing bid that a given eligible content item faces from auction-to-auction. The term σ²(x) is an estimated variance in the eCPM of the first eligible content item. The estimated variance reflects an uncertainty in a true eCPM for the first eligible content item. The term k is the number of impressions that the first eligible content item has received since it was created. The term δ is a discount factor for the first eligible content item. For example, as mentioned above, the discount factor can reflect a value of a monetary amount received in the future relative to a value amount placed on a monetary amount received today.

In some implementations, the value of learning can decrease as the uncertainty level of the expected click-through rate for the first eligible content item decreases over time. For example, as more information is known about the click-through rate and/or other performance metrics associated with the first eligible content item, the value of learning can decrease. The decrease can occur over time, for example, because there is increasingly less to learn about a content item's performance and expected performance.

In some implementations, adjusting can include increasing a score for the first eligible content item. As an example, the value of learning that is computed for the first eligible content item can typically be a positive value that increases the adjusted score.

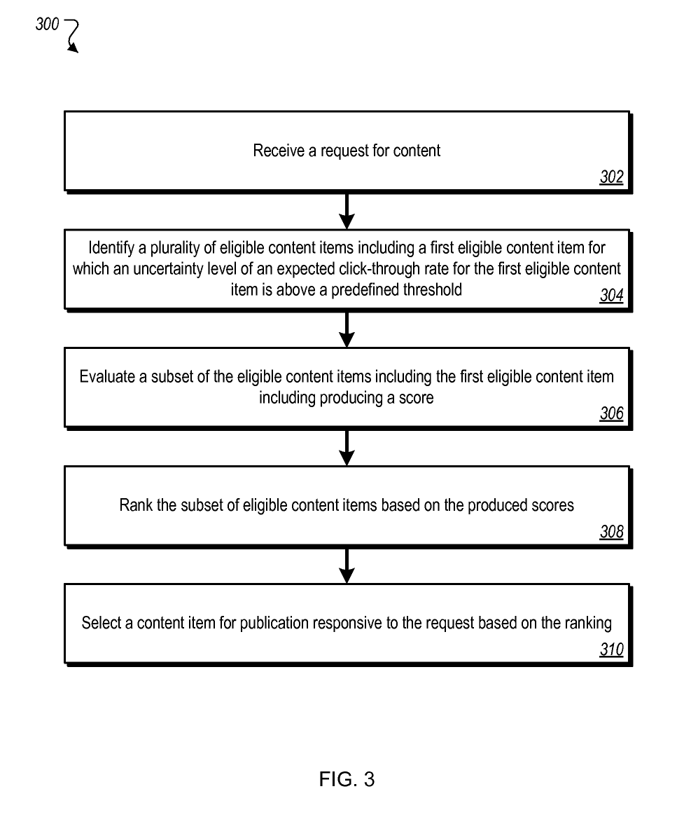

FIG. 3 is a flowchart of an example process 300 for adjusting a bid-related score for a content item by a value of learning associated with the content item's estimated performance. In some implementations, the content management system 110 can perform stages of the process 300 using instructions that are executed by one or more processors. FIGS. 1-2 are used to provide example structures for performing the steps of the process 300.

A request for content is received (302). For example, the content management system 110 can receive the request for content 202 from the user device 106. A plurality of eligible content items are identified (304). The eligible content items include a first eligible content item for which an uncertainty level of an expected click-through rate for the first eligible content item is above a predefined threshold. As an example, the content identification engine 121 can identify a plurality of eligible content items, e.g., the eligible content items 132. The identified eligible content items 132 can include the first eligible content item 132a, e.g., a new or fairly new advertisement having an insufficient number of impressions from which to accurately estimate an eCTR with a certainty above a predetermined threshold.

A subset of the eligible content items is evaluated (306). The evaluation includes evaluating the first eligible content item, including producing a score that is a product of an associated bid and a click-through rate for a given eligible content item. Producing the score for the first eligible content item includes adjusting the score (e.g., adjusting a product of a bid times an expected click-through rate for the first eligible content item) by a value of learning that represents a value for exploring the first eligible content item as a response to the request. For example, the scoring engine 122 can produce scores 212 associated with each of the eligible content items 132 and the score 214 for the first eligible content item 132a. Each of the scores 212 can be, for example, a product of an associated bid and a click-through rate for the given eligible content item. The score 214 can be, for example, an adjusted product of a bid times an expected click-through rate, including a value of learning adjustment.

The subset of eligible content items is ranked based on the produced scores (308). As an example, the ranking engine 123 can rank the subset of eligible content items 132, including the first eligible content item 132a, based on the produced scores 212 and 214.

A content item is selected for publication responsive to the request based on the ranking (310). For example, the content management system 110 can select the first eligible content item 132a as the winning content item 216 if the adjusted score 214 was determined to be higher than the scores of other eligible content items.

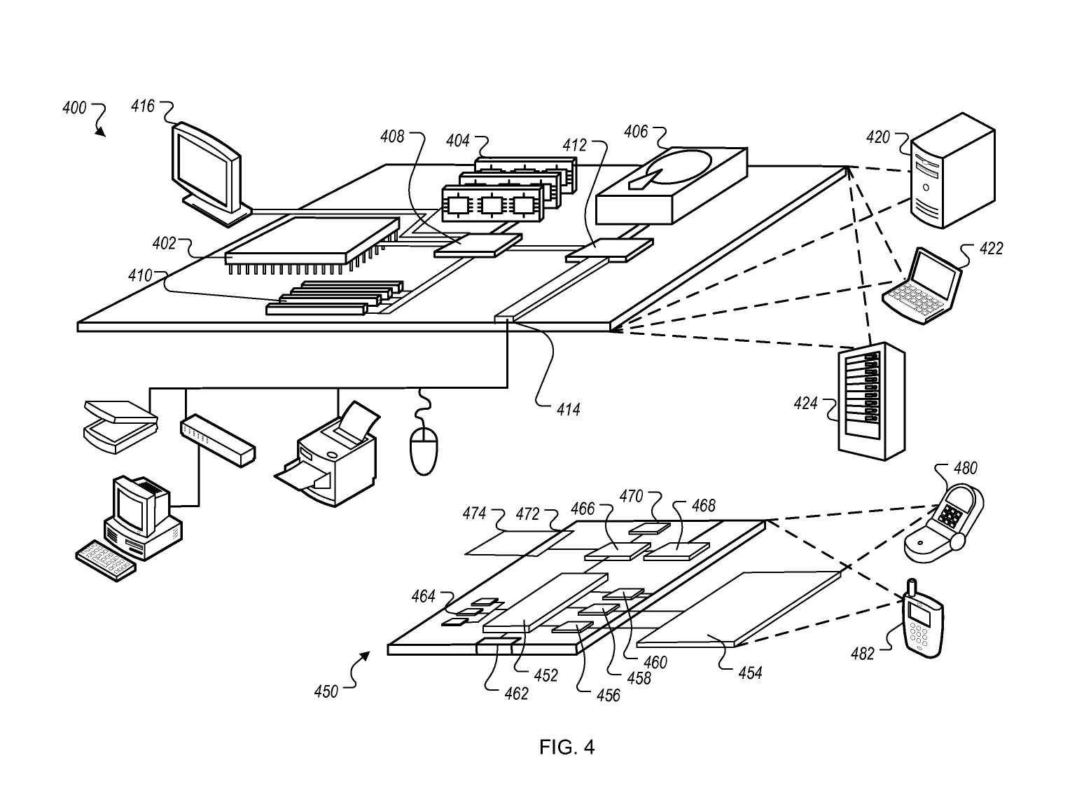

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request for content;
identifying a plurality of eligible content items including a first eligible content item for which an uncertainty level of an expected click-through rate for the first eligible content item is above a predefined threshold;
evaluating a subset of the eligible content items including the first eligible content item including producing a score, wherein the score is a product of an associated bid and a click-through rate for a given eligible content item, and wherein producing a score for the first eligible content item includes adjusting a product of a bid times expected click-through rate for the first eligible content item by a value of learning that represents a value for exploring the first eligible content item as a response to the request; and
ranking the subset of eligible content items based on the produced scores.

2. The method of claim 1 wherein the value of learning includes an adjustment for one or more of a density of distribution of highest competing bids, a time value of money discount, or a variance discount that reflects a value of learning that is varied based on how much is known already about the first eligible content item.

3. The method of claim 2 wherein the value of learning is computed using a score in accordance with the formula:
$$x + \frac{f ( x ) {σ}^{2} ( x )}{2 ( 1 - δ ) ( k + 1 )}$$
wherein x is an expected cost per thousand (eCPM) of the first eligible content item with an unknown eCPM;
wherein f(x) is a density of a distribution of highest-competing eCPM bids evaluated at x, wherein the distribution reflects a random variation in the eCPM of the highest-competing bid that a given eligible content item faces from auction-to-auction;
wherein σ²(x) is an estimated variance in the eCPM of the first eligible content item, wherein the estimated variance reflects an uncertainty in a true eCPM for the first eligible content item;
wherein k is the number of impressions that the first eligible content item has received since it was created; and
wherein δ is a discount factor for the first eligible content item.

4. The method of claim 2 wherein the density of distribution of highest competing bids accounts for random variation in competing bids that may be placed in the future that will compete with the first eligible content item.

5. The method of claim 2 wherein the time value of money discount reflects an expected value of revenue to be received in the future from auctions in which the first eligible content item will compete.

6. The method of claim 2 wherein the variance discount reduces the value of learning as more is learned about the first eligible content item.

7. The method of claim 1 wherein the value of learning decreases as the uncertainty level of the expected click-through rate for the first eligible content item decreases over time.

8. The method of claim 1 wherein adjusting includes increasing a score for the first eligible content item.

9. The method of claim 1 wherein evaluating the subset of eligible content items includes conducting an auction.

10. The method of claim 1 further comprising selecting a content item for publication responsive to the request based on the ranking.

11. A computer program product embodied in a non-transitive computer-readable medium including instructions, that when executed, cause one or more processors to:
identify a plurality of eligible content items including a first eligible content item for which an uncertainty level of an expected click-through rate for the first eligible content item is above a predefined threshold;
evaluate a subset of the eligible content items including the first eligible content item including producing a score, wherein the score is a product of an associated bid and a click-through rate for a given eligible content item, and wherein producing a score for the first eligible content item includes adjusting a product of a bid times expected click-through rate for the first eligible content item by a value of learning that represents a value for exploring the first eligible content item as a response to the request;
rank the subset of eligible content items based on the produced scores; and
select a content item for publication responsive to the request based on the ranking.

12. The computer program product of claim 11 wherein the value of learning includes an adjustment for one or more of a density of distribution of highest competing bids, a time value of money discount, or a variance discount that reflects a value of learning that is varied based on how much is known already about the first eligible content item.

13. The computer program product of claim 12 wherein the value of learning is computed using a score in accordance with the formula:
$$x + \frac{f ( x ) {σ}^{2} ( x )}{2 ( 1 - δ ) ( k + 1 )}$$
wherein x is an expected cost per thousand (eCPM) of the first eligible content item with an unknown eCPM;
wherein f(x) is a density of a distribution of highest-competing eCPM bids evaluated at x, wherein the distribution reflects a random variation in the eCPM of the highest-competing bid that a given eligible content item faces from auction-to-auction;
wherein σ²(x) is an estimated variance in the eCPM of the first eligible content item, wherein the estimated variance reflects an uncertainty in a true eCPM for the first eligible content item;
wherein k is the number of impressions that the first eligible content item has received since it was created; and
wherein δ is a discount factor for the first eligible content item.

14. The computer program product of claim 12 wherein the density of distribution of highest competing bids accounts for random variation in competing bids that may be placed in the future that will compete with the first eligible content item.

15. The computer program product of claim 12 wherein the time value of money discount reflects an expected value of revenue to be received in the future from auctions in which the first eligible content item will compete.

16. A system comprising:
a content identification engine that identifies a plurality of eligible content items from an inventory of content items, the identification based in part on characteristics of the eligible content items matching characteristics associated with a request for content, the eligible content items including a first eligible content item for which an uncertainty level of an expected click-through rate for the first eligible content item is above a predefined threshold;
a scoring engine that evaluates a subset of the eligible content items to produce scores for use in an auction for selecting at least one of the eligible contents in the subset, the scores for the eligible content items being based on a product of an associated bid and an expected click-through rate (eCTR) for the given eligible content, and the score for the first eligible content item being based on a function of a bid times an expected click-through rate and being adjusted by a value of learning that represents a value for exploring the first eligible content item as a response to the request;
a ranking engine that ranks the subset of eligible content items, including the first eligible content item, using the associated scores; and
a request handler that handles requests for content received by a content management system, the content management system selecting and providing content in response to requests for content.

17. The system of claim 16 wherein the value of learning includes an adjustment for one or more of a density of distribution of highest competing bids, a time value of money discount, or a variance discount that reflects a value of learning that is varied based on how much is known already about the first eligible content item.

18. The system of claim 17 wherein the value of learning is computed using a score in accordance with the formula:
$$x + \frac{f ( x ) {σ}^{2} ( x )}{2 ( 1 - δ ) ( k + 1 )}$$
wherein x is an expected cost per thousand (eCPM) of the first eligible content item with an unknown eCPM;
wherein f(x) is a density of a distribution of highest-competing eCPM bids evaluated at x, wherein the distribution reflects a random variation in the eCPM of the highest-competing bid that a given eligible content item faces from auction-to-auction;
wherein σ²(x) is an estimated variance in the eCPM of the first eligible content item, wherein the estimated variance reflects an uncertainty in a true eCPM for the first eligible content item;
wherein k is the number of impressions that the first eligible content item has received since it was created; and
wherein δ is a discount factor for the first eligible content item.

19. The system of claim 17 wherein the density of distribution of highest competing bids accounts for random variation in competing bids that may be placed in the future that will compete with the first eligible content item.

20. The system of claim 17 wherein the time value of money discount reflects an expected value of revenue to be received in the future from auctions in which the first eligible content item will compete.
